(19) United States
(12) Patent Application Publication
(10) Pub. No.: US 2015/0350686 A1
(43) Pub. Date: Dec. 3, 2015

(54) PREENCODER ASSISTED VIDEO ENCODING

(71) Applicant: Apple Inc., Cupertino, CA (US)

(72) Inventors: Xiaosong Zhou, Campbell, CA (US); Chris Y. Chung, Sunnyvale, CA (US); David R. Conrad, Sunnyvale, CA (US); Dazhong Zhang, Milpitas, CA (US); Feng Yi, San Jose, CA (US); Hsi-Jung Wu, San Jose, CA (US); Jae Hoon Kim, San Jose, CA (US); Jiefu Zhai, San Jose, CA (US); Peikang Song, San Jose, CA (US); Yunfei Zheng, Cupertino, CA (US)

(73) Assignee: Apple Inc., Cupertino, CA (US)

(21) Appl. No.: 14/290,304

(22) Filed: May 29, 2014

(51) Int. Cl. H04N 19/85; H04N 19/115; H04N 19/517; H04N 19/51; H04N 19/172; H04N 19/176

(52) U.S. Cl. CPC H04N 19/85; H04N 19/172; H04N 19/176; H04N 19/517; H04N 19/51; H04N 19/115

(57) ABSTRACT

A method and system of using a pre-encoder to improve encoder efficiency. The encoder may conform to ITU-T H.265 and the pre-encoder may conform to ITU-T H. 264. The pre-encoder may receive source video data and provide information regarding various coding modes, candidate modes, and a selected mode for coding the source video data. In an embodiment, the encoder may directly use the mode selected by the pre-encoder. In another embodiment, the encoder may receive both the source video data and information regarding the various coding modes (e.g., motion information, macroblock size, intra prediction direction, rate-distortion cost, and block pixel statistics) to simplify and/or refine its mode decision process. For example, the information provided by the pre-encoder may indicate unlikely modes, which unlikely modes need not be tested by the encoder, thus saving power and time.

### BACKGROUND

The present invention relates to a method and system of video encoding and compression. More specifically, it relates to methods for pre-encoding processes that assist and optimize video encoding systems such as within the High Efficiency Video Coding (HEVC) standard.

The HEVC standard, currently published as ISO/IEC 23008-2 MPEG-H Part 2 and ITU-T H.265, introduced several new video coding tools designed to improve video coding efficiency over previous video coding standards and technologies such as MPEG-2, MPEG-4 Part 2, MPEG-4 AVC/H.264 (“AVC”), VC1, and VP8. HEVC standardizes a bitstream's structure, syntax, and mapping for generation of decoded pictures. Encoders typically duplicate a decoder processing loop to support prediction operations that are synchronized to decoder operation (absent transmission errors). HEVC encoders that are configured as software encoders may provide a broader range of prediction searches compared with a hardware encoder, but typically require more power and has relatively high latency. HEVC encoders that are configured as hardware encoders may be faster at runtime compared with software encoders, but typically cannot cache as quickly. The inventors perceive a need in the art for an encoding process that is efficient, e.g., having both low latency and low power consumption. There is no known system that has the speed of hardware encoders and the breadth of prediction range of software encoders.

### BRIEF DESCRIPTION OF THE DRAWINGS

FIG. 1 is a simplified block diagram of a video coding system according to an embodiment of the present invention.

FIG. 2 is a functional block diagram of a video processing system according to an embodiment of the present invention.

FIG. 3A is a functional block diagram of a configuration of a video processing system according to an embodiment of the present invention.

FIG. 3B is a functional block diagram of a configuration of video processing system according to an embodiment of the present invention.

FIG. 4 is a flowchart of a method of coding video data based on pre-encoder information according to an embodiment of the present invention.

FIG. 5 is a flowchart of a method of motion estimation in a coding process based on pre-encoder information according to an embodiment of the present invention.

### DETAILED DESCRIPTION

The inventors have developed a method of video coding that includes a pre-encoding process that assists an encoding process by increasing the efficiency and compression quality of the encoding process. The pre-encoding process may be implemented in software or hardware, and may be based on existing standards such as AVC. The pre-encoder may code a picture and output encoding results such as mode decision information, which may provide a hint to the encoder regarding optimal compression modes. The encoder may receive the source picture along with the results provided by the pre-encoder. The results may guide the encoder's compression process, e.g., reducing the number of testing modes in determining a coding type. This may improve the efficiency of the encoder's compression process by providing a starting point for testing modes and performing motion estimation compared with starting without any hints.

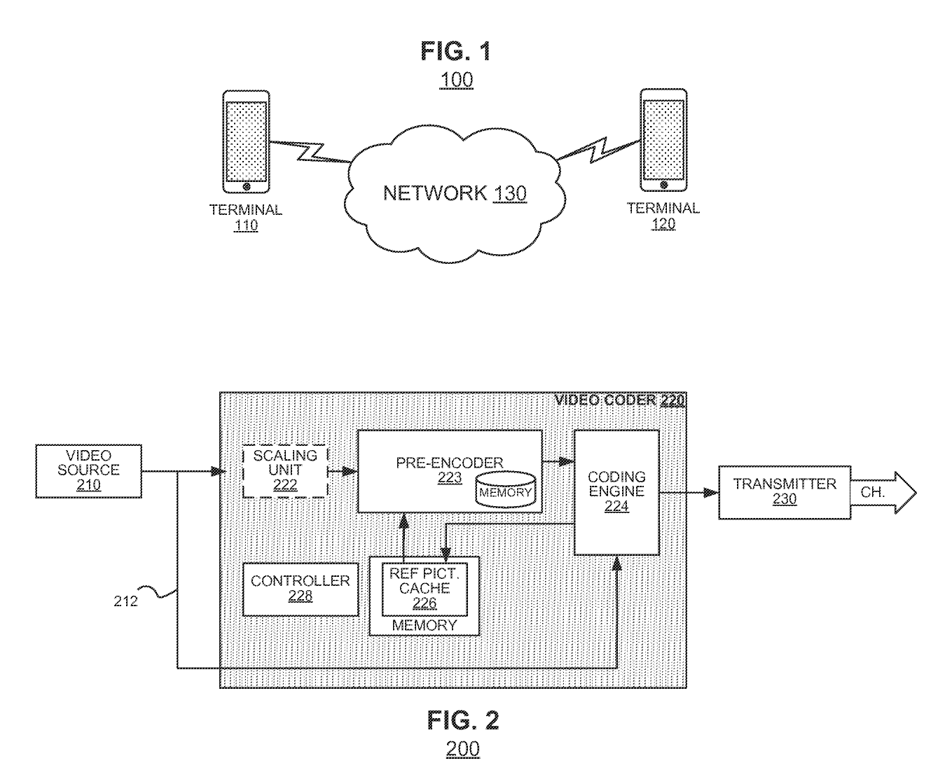

FIG. 1 is a simplified block diagram of a video coding system 100 according to an embodiment of the present invention. The system 100 may include a plurality of terminals 110, 120 interconnected via a network 130. The terminals 110, 120 each may capture video data at a local location and code the video data for transmission to the other terminal via the network 130. Each terminal 110, 120 may receive the coded video data of the other terminal from the network 130, reconstruct the coded data and display video data recovered therefrom.

In FIG. 1, the terminals 110, 120 are illustrated as smart phones but the principles of the present invention are not so limited. Embodiments of the present invention find application with personal computers (both desktop and laptop computers), tablet computers, computer servers, media players and/or dedicated video conferencing equipment.

The network 130 represents any number of networks that convey coded video data between the terminals 110, 120, including for example wireline and/or wireless communication networks. The communication network 130 may exchange data in circuit-switched or packet-switched channels. Representative networks include telecommunications networks, local area networks, wide area networks and/or the Internet. For the purposes of the present discussion, the architecture and topology of the network 130 are immaterial to the operation of the present invention unless explained herein.

FIG. 2 illustrates a functional block diagram of a pre-encoder assisted video processing system 200 according to an embodiment of the present invention. The system 200 may include a video source 210, video coder 220, and transmitter 230. The video source 210 may capture video data and generate a video data signal therefrom. The video coder 220 may code the video signal for transmission over a channel. The transmitter 230 may build a channel data signal from the coded video data and other data sources (coded audio data and ancillary data), format the channel data signal for transmission and transmit it to the channel.

As illustrated, the video coder 220 may include a scaling unit 222, a pre-encoder 223, a coding engine 224 and a reference picture cache 226 operating under control of a controller 228. The pre-encoder 223 may accept an input video signal either from the video source 210 or the scaling unit 222, and may code it according to a first compression protocol. The pre-encoder 223 may analyze the input video to determine its attributes and select coding modes according to its coding processes. The pre-encoder may output coded data and/or other intermediate data during its coding process to the coding engine 224. In an embodiment, the pre-encoder 223 may be a first functional unit within the terminal 200 with a predefined set of resources for coding. For example, it may be a hardware coder, such as an application-specific integrated circuit (ASIC) or a digital signal processor (DSP).

The coding engine 224 may perform compression operations on the source video 212 according to a second compression protocol. The coding engine 224 may output coded video data to the transmitter 230 conforming to a specified standard. As part of its operation, the coding engine 224 may also take into consideration coding modes and input source video attributes identified in data provided by the pre-encoder 223 as it codes new frames of video data, according to motion prediction techniques using data stored in the reference picture cache 226 as a prediction reference. The coding engine 224 further may include a decoder to reconstruct coded video data of the reference frames for storage in the reference picture cache 226.

The pre-encoder 223 may perform a variety of video processing operations on the source video output from the video source. The pre-encoder 223 may compress the images by a motion-compensated prediction. Frames of the input video may be assigned a coding type, where the coding type used is determined by testing various coding modes. In some coding modes, pixel blocks of frames may be coded according to temporal prediction, in which case, the pre-encoder 223 may perform a motion estimation search to identify pixel blocks from frames stored in the reference picture cache 226 that may provide an adequate prediction reference for pixel blocks of a new frame to be coded. The pre-encoder may calculate motion vectors identifying pixel blocks of reconstructed frames stored in the reference picture cache 226 that are used as predictions of the pixel blocks being coded and may generate prediction residuals prior to engaging the transform coding. In cooperation with the controller 228, the pre-encoder's selection of coding parameters may be provided to the coding engine 224 as part of the pre-encoder's coded representation of source video 212. In an embodiment, the pre-encoder may operate according to coding protocols defined by ITU-T H.264 and the like.

The coding engine 224 may code input video data according to a second protocol to achieve compression. The coding engine 224 also may compress the images by a motion-compensated prediction. Frames of the input video may be assigned a coding type, such as intra-coding (I-coding), uni-directionally predictive coding (P-coding) or bi-directionally predictive coding (B-coding). The type of coding used may be determined in a mode decision process in which the coding engine tests various modes to determine the coding mode for a current sample or group of frames. The mode decision process may be informed by the candidate modes and/or frame attributes provided by the pre-encoder. The frames further may be parsed into a plurality of pixel blocks and may be coded by transform coding, quantization and entropy coding. Pixel blocks of P- and B-coded frames may be coded according to temporal prediction, in which case, the video coder 220 may perform a motion estimation search to identify pixel blocks from frames stored in the reference picture cache 226 that may provide an adequate prediction reference for pixel blocks of a new frame to be coded. The coding engine 224 may calculate motion vectors identifying pixel blocks of reconstructed frames stored in the reference picture cache 226 that are used as predictions of the pixel blocks being coded and may generate prediction residuals prior to engaging the transform coding. The motion estimation search may be replaced by a counterpart in the pre-encoder or simplified according to the techniques discussed herein. In some instances rate control may be improved. For example, the coding engine may drop a frame based on the pre-encoder's calculations. In some cases, even where a pre-encoder codes a frame, a coding engine may drop the frame based on analysis of the pre-encoder's decision process. In an embodiment, the video encoder may operate according to coding protocols defined by ITU-T H.265 and the like.

The pre-encoder 223 may be implemented as software or hardware. In some instances, the pre-encoder may already be available as a hardware encoder in a coding system. In embodiments in which the pre-encoder 223 is implemented as hardware and the encoder 224 is implemented as software, the pre-encoder 223 may be faster than the encoder 224. The hardware pre-encoder 223 may be fast, but may have limited resources for prediction, e.g., using and storing just a few reference frames. Thus, it might not always use the full capability of the standard to which it conforms, but may operate at high speeds. The pre-encoder 223 and the encoder 224 may perform similar operations to code the input video data, and thus the pre-encoder's coding parameters and coding decisions, which are derived quickly, may be used by speed up the encoder's coding processes.

The reference picture cache 226 may store a predetermined number of reconstructed reference frames. The coding engine 224 may include a decoder (not shown) to reconstruct coded reference picture frames from the coded video data. Thus, the video coder 220 may generate a local copy of the reconstructed reference frames that will be obtained by a video decoder (not shown) when it reconstructs the coded video data. These reconstructed reference picture frames may be stored in the reference picture cache 226. The reference picture cache 226 may have a predetermined cache depth; for example, video coders 220 operating in accordance with the AVC standard may store up to sixteen (16) reconstructed reference pictures. Both the pre-encoder 223 and the coding engine 224 may use reference frames output by coding engine 224 for purposes of motion compensation prediction. The optional scaling unit 222 may condition an input source video for coding and analysis by the pre-encoder 223, e.g., it may scale down a reference picture.

The pre-encoder 223 may improve the efficiency of the coding engine's compression process by outputting one or more coding parameters, e.g., modes of prediction and attributes of a source video frame. The coding of the source video may be performed in one or more predictive modes selected from among several candidate modes, at least some of which may be provided by the pre-encoder 223. This may render compression more efficient by providing a starting point for the coding engine 224 in determining a compression mode, e.g., an optimal compression mode. Because the coding parameters selected by the pre-encoder are likely similar to those of the encoder, the number of compression modes likely to be selected by the coding engine is narrowed down by the results provided by the pre-encoder, which reduces the possible modes to be tested in the mode decision process and simplifies the motion estimation process. Based on the pre-encoder's result, the coding engine may also adjust its coding parameter settings to improve the coding quality. Unlike a conventional transcoder, which receives a bitstream from an encoder, decodes and analyzes the bitstream, then re-encodes the data into a conforming bitstream, the coding engine 224 considers both a substantially un-modified source video and mode possibilities output by the pre-encoder 223.

In an embodiment, the pre-encoder 223 may use one coding protocol (e.g., ITU-T H.264 AVC) and coding engine 224 may use a different coding protocol (e.g., ITU-T H.265 HEVC). When the pre-encoder and coding engine operate under different coding standards, they may share some similar characteristics, e.g., block-based structure, prediction modes (e.g., inter mode or intra mode), motion information, transform type and size, and quantization. However, these characteristics are typically not identical, e.g., compared with AVC, HEVC generally uses quad-tree coding unit (“CU”) structures, more accurate interpolation filters, different transforms, more intra prediction directions, etc. Thus, the pre-encoder results may be adapted for used by the coding engine 224 according to the techniques described herein.

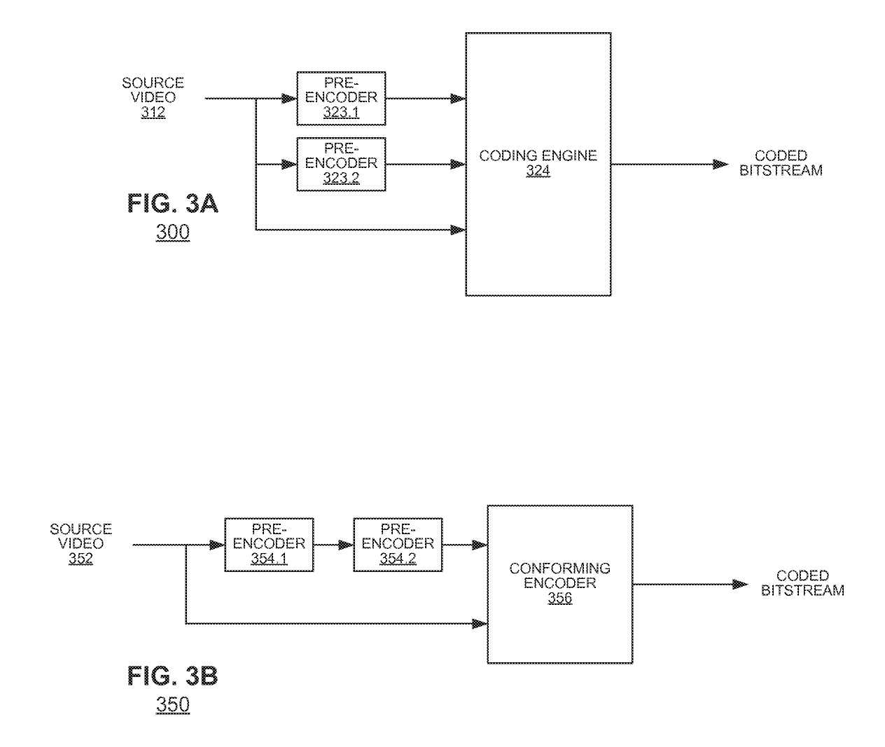

FIG. 3A shows a configuration of a video processing system 300 in which multiple pre-encoders may be connected in parallel. Pre-encoding may be applied to the input source video multiple times to obtain more information. Each pre-encoder may also search different reference ranges to output various candidate modes. Each of the pre-encoders 323.1, 323.2 connected in parallel may output coded data to coding engine 324. The coding engine 324 may feed its coding decision using coding parameters from pre-encoding 323.1 and other coding parameters from pre-encoder 323.2.

FIG. 3B shows a configuration of a video processing system 300 in which multiple pre-encoders may be connected in series. Pre-encoding may be applied to the input source video in multiple passes to obtain more information. In an embodiment, parameters used for one pass may differ from parameters used for another pass. For example, one pre-encoder 354.1 may receive an input frame from source video 352 and may perform spatial and temporal analysis on the input frame. Based on the analysis, a rate control of coding engine 356 may determine parameters, for example frame and/or block quantization parameters (“QP”). The determined parameters may then be used by pre-encoder 354.2. In an example of re-encoding, one pre-encoder 354.1 may encode an input frame with specifiable parameters, and the output of the pre-encoder may be evaluated to determine whether or not to re-encode the results of pre-encoder 354.2, for example, using another pre-encoder 354.2. A decision to re-encode may be made if re-encoding is projected to result in a better trade-off of quality and bits. The parameters that may be adjusted between a first pre-encoder 354.1 and a second pre-encoder 354.2 may include frame QP, block QP (e.g., for QP modulation), mode decision bias, motion estimation lambda, deblocking parameters, rounding offsets, weighted prediction parameters, and the like.

Each pre-encoder may also search different reference ranges to output various candidate modes. Each of the pre-encoders 323.1, 323.2 connected in parallel may output coded data to coding engine 324. The coding engine 324 may feed its coding decision using coding parameters from pre-encoding 323.1 and other coding parameters from pre-encoder 323.2.

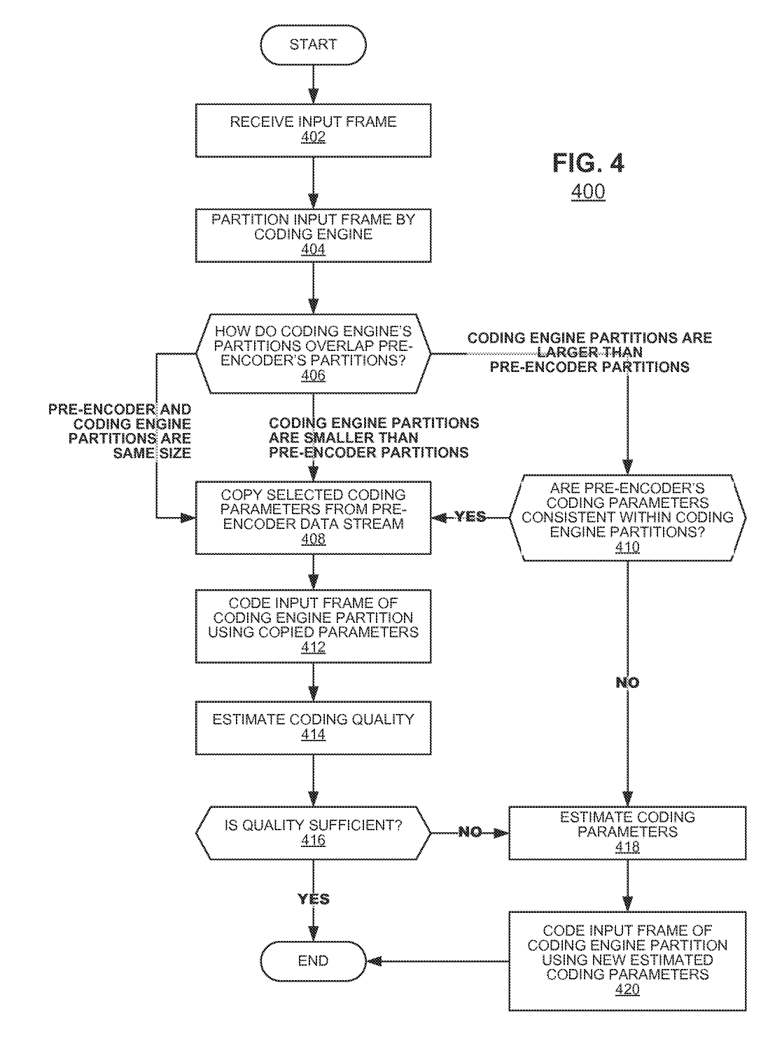

FIG. 4 illustrates a method 400 of using coding parameters selected by a pre-encoder for a coding engine's compression process. For example, a coding engine 224 may perform method 400. Typically if a coding engine's partitions are larger than a pre-encoder's partitions or if the coding quality of the pre-encoder is insufficient, the output of the pre-encoder is not suitable for direct use. In such situations, pre-encoder information may be useful as a starting point for further refinement in the coding engine's compression processes. It is also possible that a pre-encoder's selected coding parameters are not suitable for use by the encoder, and the encoder may instead estimate its own coding parameters and perform compression processes without using information provided by the pre-encoder.

In box 402, the method 400 may receive an input frame. The method 400 may partition the input frame, for example, according to the protocol to which it conforms (box 404). In box 406, the method 400 may compare a partition size used by the pre-encoder and a partition size used by the coding engine to determine how the partitions might overlap. If the partition size of the coding engine is smaller than or equal to the partition size of the pre-encoder, the method may proceed to box 408, in which the method 400 may copy selected coding parameters from the pre-encoder's data stream. The selection of the coding parameters may be based on motion information, block type, intra-prediction mode direction, transform type, etc. as further discussed herein. The smaller or same block size of the pre-encoder may indicate that the pre-encoder's compression processes are adequate and may be directly used by the coding engine to eliminate or reduce the number of costly compression calculations.

If the method 400 determines that the block size of the encoder is larger than the block size of the pre-encoder, then the method 400 may then determine whether the pre-encoder's coding parameters are consistent with the coding engine's partitions (box 410). If the pre-encoder's coding parameters are consistent with the coding engine's partitions, this may indicate that the pre-encoder's selected coding parameters are suitable for use by the coding engine despite the block size mismatch, and the coding parameters selected by the pre-encoder may be copied or summarized to the coding engine (box 408). For example, if the pre-encoder's block size is 8×8 and the coding engine's block size is 16×16, depending on the content of a frame, the pre-encoder's block size may nonetheless be representative of the coding engine's larger partition size.

After copying selected coding parameters from a pre-encoder data stream in box 408, in box 412, the method 400 may code the source video input frame as partitioned by the coding engine using the parameters copied from the pre-encoder. As further discussed herein, this may save the coding engine time and/or power. In box 414, the method 400 estimates the coding quality of the coding performed in box 412. Based on the quality estimate, the method 400 may determine whether the quality of the coding using the pre-encoder's selected coding parameters is sufficient for use by the coding engine (box 416). It is possible that, despite sharing the same or having larger partitions, the pre-encoder's compression processes yield parameters that, when used by the coding engine, are not sufficiently accurate. The quality of the coding engine's compression methods using the pre-encoder's parameters may be determined based on error checking and estimation of the frame. If the quality is sufficient, then the method 400 may end or the coding engine may proceed to evaluate a next input frame, repeating steps 402 to 420 of method 400 until a source video stream is coded.

If the quality is determined in box 416 to be insufficient or if the pre-encoder's coding parameters are determined in box 410 to be inconsistent with the coding engine's partitions, then the coding engine may proceed to estimate coding parameters according to its own compression algorithms (box 418). This indicates that the pre-encoder's calculations may not be suitable for the coding engine due to the difference in their respective compression processes for a particular partition size and/or the currently-evaluated input frame. It is possible that for a subsequent frame, the pre-encoder's selected coding parameters would be appropriate for use or refinement by the coding engine. After estimating the coding parameters, the method 400 may proceed to box 420 to code the source video input frame partitioned by the coding engine using the parameters estimated in box 418. The method 400 may then end or the coding engine may proceed to evaluate a next input frame, repeating steps 402 to 420 of method 400 until a source video stream is coded.

The factors a pre-encoder may consider in a compression process and usable by the encoder for its compression process include: motion information, macroblock type, sub-macroblock type, intra-prediction mode direction, transform type, bits distribution, and input source statistics (e.g. variance, gradient, mean values, and the like). These factors may be used to select a mode and corresponding motion vector by which to code the video data. Additionally, an AVC pre-encoder may also output information regarding deblocking boundary strength; weighting for prediction parameters; a distortion, rate, and cost for each tested mode of each block; and block pixel statistics. The mode ultimately selected by the pre-encoder and each of the factors considered by the pre-encoder in the mode decision process may be used by the coding engine 224 to efficiently select a mode by which to code and output a bitstream conforming to the standard of the coding engine.

Motion estimation is typically one of the most power consuming processes for an HEVC encoder. Thus, motion information calculated and provided by a pre-encoder may be used to reduce or simplify the motion estimation calculations performed by a coding engine, e.g., an HEVC encoder. For example, motion information provided by a pre-encoder may be directly used by an encoder or it may form a basis from which the HEVC encoder may refine its motion estimation search.

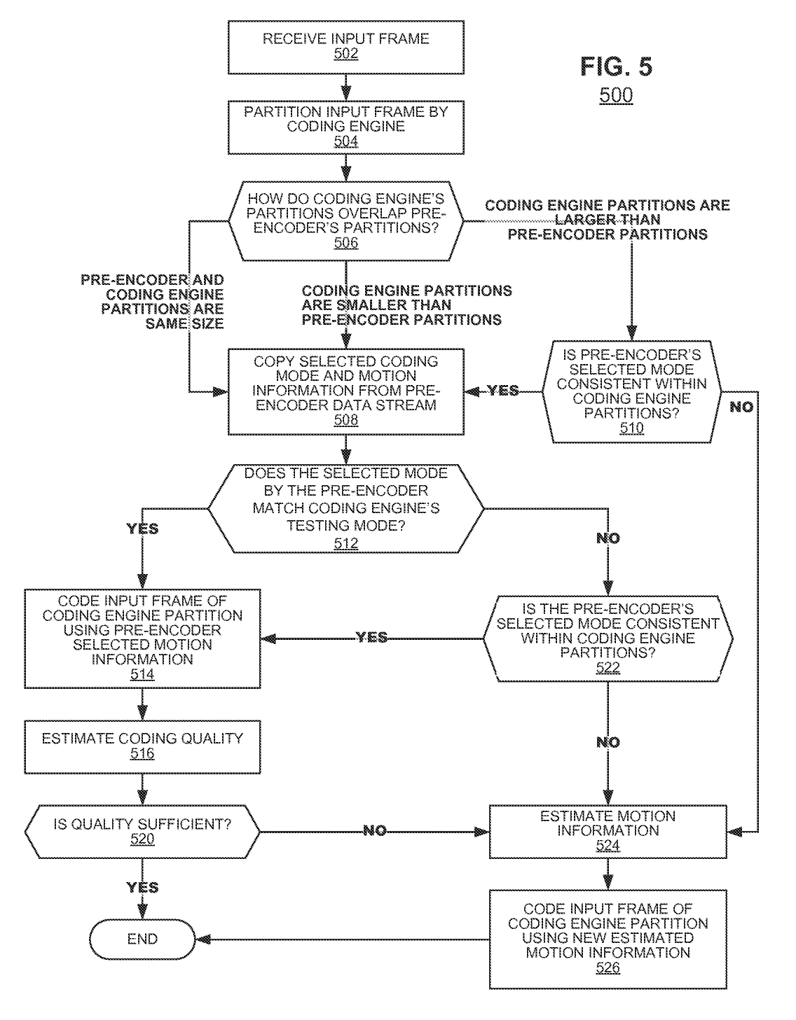

FIG. 5 illustrates a method 500 of using one type of coding parameter (mode decision and motion information) calculated by a pre-encoder for a coding engine's compression process. For example, a coding engine 224 may perform method 500 while testing a mode during a mode decision process. In box 502, the method 500 may receive an input frame. The method 500 may partition the input frame, for example, according to the protocol to which it conforms (box 504). In box 506, the method 500 may compare a partition size used by the pre-encoder and a partition size used by the coding engine to determine how the partitions might overlap. If the partition size of the coding engine is smaller than or equal to the partition size of the pre-encoder, the method may proceed to box 508, in which the method 500 may copy selected coding mode and motion information from the pre-encoder's data stream.

If the method 500 determines that the block size of the encoder is larger than the block size of the pre-encoder, then the method 500 may determine whether the pre-encoder's selected mode is consistent with the coding engine's partitions (box 510). If the pre-encoder's selected mode is consistent with the coding engine's partitions, this may indicate that the pre-encoder's selected mode and corresponding motion information are suitable for use by the coding engine despite the block size mismatch, and the mode and corresponding motion information selected by the pre-encoder may be copied to the coding engine (box 508).

After copying mode and motion information from a pre-encoder data stream in box 508, in box 512, the method 500 may determine whether the mode selected by the pre-encoder matches a mode that the coding engine is currently testing. If the selected mode matches the mode being tested by the coding engine, motion information (e.g., a motion vector) corresponding to the mode selected by the pre-encoder may be used directly by the coding engine (box 514). This is because when the mode selected by a pre-encoder matches a current testing mode with the same block size, the corresponding motion information determined by the pre-encoder is likely the same as what would result from motion estimation processes by the coding engine. Thus, power-consuming and relatively complex motion estimation processes by the coding engine may be skipped, and instead the motion information determined by the pre-encoder may be directly used by the coding engine.

If, on the other hand, the method 500 determines in box 512 that the mode does not match the current testing mode, the method 500 may proceed to box 522 in which it determines whether the pre-encoder's selected mode, although not matching the current testing mode, is consistent within the coding engine's partitions. If so, the method 500 may proceed to box 514.

In box 514, the method 500 may code the source video input frame as partitioned by the coding engine using the motion information associated with the mode copied from the pre-encoder. By considering motion information (e.g., a motion vector and a reference index of each partition) provided by the pre-encoder, the coding engine may skip or simplify its motion estimation process.

In box 516, the method 500 may estimate a quality of the coding performed in box 514. Based on the quality estimate, the method 500 may determine whether the quality of the coding using the pre-encoder's selected coding parameters is sufficient for use by the coding engine (box 520). It is possible that, despite (i) sharing the same or having larger partitions and/or (ii) sharing the same mode, the pre-encoder's compression processes yield parameters that, when used by the coding engine, are not sufficiently accurate. The quality of the coding engine's compression methods using the pre-encoder's parameters may be determined based on error checking and estimation of the frame. If the quality is sufficient, then the method 500 may end or the coding engine may proceed to evaluate a next input frame, repeating steps 502 to 526 of method 500 until a source video stream is coded.

If the quality is determined in box 520 to be insufficient or if the pre-encoder's coding mode is determined in box 522 to be inconsistent with the coding engine's partitions, then the coding engine may proceed to estimate coding motion information according to its own compression algorithms (box 524). This indicates that the pre-encoder's calculations may not be suitable for the coding engine due to the difference in their respective compression processes for a particular mode, partition size and/or the currently-evaluated input frame. After estimating the coding parameters, the method 500 may proceed to box 526 to code the source video input frame partitioned by the coding engine using the motion information estimated in box 524. As discussed further herein, it is possible that for a subsequent frame, the pre-encoder's selected coding parameters would be appropriate for use or refinement by the coding engine. The method 500 may then end or the coding engine may proceed to evaluate a next input frame, repeating steps 502 to 526 of method 500 until a source video stream is coded. Thus, the pre-encoder may simplify the motion estimation process of the encoder by providing a starting point for the encoder's motion estimation process.

Another power-consuming aspect of compression processes is testing various mode possibilities in a mode decision process, especially if the possible modes are numerous. Power consumption may be reduced by using macroblock type and sub-macroblock type information provided by a pre-encoder to reduce the number of possible modes that an encoder tests during a mode decision process. A macroblock type (mb_type) and/or a sub-macroblock type (sub_mb_type) may indicate the type of prediction mode (e.g., inter-prediction, intra-prediction, or skip) and a partition size used by the pre-encoder.

Based on the prediction mode used by the pre-encoder, the encoder may trim unlikely possibilities for modes, which may avoid or reduce the expense of testing modes, especially intra-mode prediction. Based on the partition size used by the pre-encoder, the encoder may test only those partitions smaller than or equal to the partition size used by the pre-encoder. For example, if an mb_type of a pre-encoder indicates that a current 16×16 block is intra-prediction coded, the encoder may skip inter-prediction modes, and instead check intra-prediction modes for 16×16 or smaller coding units, prediction units, and/or transform units.

As another example, if an mb_type of a pre-encoder indicates that a current 12×16 block is inter-prediction coded in 16×8 mode, the encoder may check 2N×N mode at 16×16 CU size. In yet another example, if an mb_type of a pre-encoder indicates that a macroblock is an 8×8 partition, the encoder may check CU sizes of 8×8 and below (and not check CU sizes larger than 8×8). Such a situation may arise when a sample is very textured. An encoder may exploit a pre-encoder's ability to pick up textureness of a block (via a mb_type) to avoid checking larger partition sizes.

Under HEVC, intra prediction operates based on transform block size, where previously decoded boundary samples from neighbor transform blocks are used to form a prediction signal. 33 possible different directional orientations are defined for square transform sizes. Additionally, planar prediction and DC prediction may also be used. A pre-encoder may indicate whether intra prediction was used, and if so, luma and/or chroma intrapicture prediction directions.

If an intra prediction mode is used by the pre-encoder, the type of intra prediction mode used may indicate an orientation of an edge within a block. Based on this information, an encoder may limit the possible intra prediction mode directions to check during its mode decision process. Because the orientation of the edge within the block indicated by the pre-encoder is the most likely direction for the encoder, the encoder may save power by testing the directions indicated by the orientation of the edge according to the pre-encoder. Although there are fewer possible directions (8) under the AVC standard compared with the possible directions under the HEVC standard, knowing the direction selected by an AVC pre-encoder may significantly narrow down the possible directions tested by an HEVC encoder. For example, a vector used by the pre-encoder may be selected and may be used as a starting point for the encoder's search for mode directions. Block statistics provided by the pre-encoder (further described herein) may also indicate an orientation of an edge within a block. For example, block statistics regarding variance and gradient may indicate a low or DC prediction mode.

In another embodiment, the pre-encoder may provide information regarding a rate distortion cost (RD cost) of a mode being tested by the encoder. A rate distortion cost may indicate a block's status, and provide an indication of how the block is partitioned, which reference frame an encoder might try first, and modes that have already been selected and tested. For example, if the RD cost of a 16×16 mode is much higher than a 16×8 mode, this may suggest that a block should be divided into pieces for prediction. This provides another direction for the encoder to prune unnecessary testing modes.

In a further embodiment, a pre-encoder may provide block pixel statistics such as variance, mean, and gradient. The block pixel statistics may be determined from spatial analysis of pixels, with a different set of block pixel statistics yielded for each partition. The block pixel statistics may indicate a complexity and/or orientation of an edge of block. For example, a gradient may indicate a dominant edge direction of a block. Based on the dominant edge direction of the block, a related partition or prediction direction may be tested by the encoder in a mode decision process while other unlikely directions are not tested to conserve power consumption. Also, based on the dominant edge direction, a bit budget and frame completion may also be determined by the encoder. Based on mean and variance, a quantization parameter used by an encoder for a block may be set or adjusted.

In yet another embodiment, an encoder may directly transcode the preencoded results without applying refinements. The transcoding mode may be adaptively enabled and disabled, for example on a block-by-block basis, regional, or frame-by-frame basis. In this case, a mapping may be defined between the pre-encoder, e.g., operating under the AVC standard, and the encoder, e.g., operating under the HEVC standard. For example, a 16×16 block can be mapped to a 2N×2N mode based on a motion vector and mode information.

The foregoing discussion has described operation of the embodiments of the present invention in the context of terminals that embody encoders and/or decoders. Commonly, these components are provided as electronic devices. They can be embodied in integrated circuits, such as application specific integrated circuits, field programmable gate arrays and/or digital signal processors. Alternatively, they can be embodied in computer programs that execute on personal computers, notebook computers, tablet computers, smartphones or computer servers. Such computer programs typically are stored in physical storage media such as electronic-, magnetic- and/or optically-based storage devices, where they are read to a processor under control of an operating system and executed. Similarly, decoders can be embodied in integrated circuits, such as application specific integrated circuits, field-programmable gate arrays and/or digital signal processors, or they can be embodied in computer programs that are stored by and executed on personal computers, notebook computers, tablet computers, smartphones or computer servers. Decoders commonly are packaged in consumer electronics devices, such as gaming systems, DVD players, portable media players and the like; and they also can be packaged in consumer software applications such as video games, browser-based media players and the like. And, of course, these components may be provided as hybrid systems that distribute functionality across dedicated hardware components and programmed general-purpose processors, as desired.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. Unless described otherwise herein, any of the methods may be practiced in any combination, e.g., interleaved. For example a first frame may be refined, and a second frame may be directly used without refinement, etc. The level of refinement may also be defined based on a region and differ from region to region based on regional interest.

We claim:

1. A video coder, comprising:
a first pre-encoder receiving source video data and outputting coded video data therefrom;
a coding engine receiving the source video data and the first coded video data from the first pre-encoder, and coding the source video data using at least one coding parameter derived from the first coded video data of the first pre-encoder, the coding engine generating second coded video data;
a transmitter to transmit the second coded video data to a channel.

2. The video coder of claim 1, wherein the coding engine consumes less power for the coding of the source video data using the at least one coding parameter derived from the first coded video data compared with coding the source video data without using the at least one coding parameter.

3. The video coder of claim 1, further comprising a second pre-encoder coupled in parallel with the first pre-encoder to receive the source video data and generate third coded video data;
wherein the coding engine derives a second coding parameter from the third coded video data and codes source video based on the second coding parameter.

4. The video coder of claim 1, further comprising a second pre-encoder coupled between the first pre-encoder and the coding engine to receive the first coded video data and the at least one coding parameter and to generate a second coding parameter and third coded video data;
wherein the coding engine derives a third coding parameter from the third coded video data and codes source video based on at least one of the second coding parameter and the third coding parameter.

5. The video coder of claim 1, wherein the first coded video data conforms to a first coding protocol and the second coded video data conforms to a second coding protocol different from the first coding protocol.

6. The video coder of claim 1, wherein the first coding protocol is ITU-T H.264 and the second coding protocol is ITU-T H. 265.

7. The video coder of claim 1, wherein the coding engine derives motion vectors from motion vectors in the first coded video data associated with co-located partitions.

8. The video coder of claim 1, wherein the coding engine derives a reference index from a reference index in the first coded video data associated with co-located partitions.

9. The video coder of claim 1, wherein the coding engine derives coding modes from coding modes in the first coded video data associated with co-located partitions.

10. The video coder of claim 1, wherein the coding engine derives at least one intra prediction direction from at least one intra prediction direction in the first coded video data associated with co-located partitions.

11. A coding method, comprising:
receiving a portion of video data;
partitioning the portion of video data;
copying at least one coding parameter calculated by a pre-encoder; and
coding the portion of video data using the copied at least one coding parameter;
wherein the pre-encoder calculates the at least one coding parameter based on the portion of video data.

12. The method of claim 11, wherein the portion of video data is a frame.

13. The method of claim 11, wherein the portion of video data is a block.

14. The method of claim 11, wherein the at least one coding parameter calculated by the pre-encoder is copied responsive to a determination that a size into which the portion of video data is partitioned is one of: (a) the same and (b) smaller than, a partition size determined by the pre-encoder.

15. The method of claim 14, wherein the at least one coding parameter calculated by the pre-encoder includes at least one of macroblock type and sub-macroblock type, the at least one of macroblock type and sub-macroblock type indicating a prediction mode and a partition size used by the pre-encoder.

16. The method of claim 15, wherein the determination of a relative partition size of the method and the pre-encoder is based on the at least one of macroblock type and sub-macroblock type.

17. The method of claim 11, wherein the at least one coding parameter calculated by the pre-encoder is copied responsive to a determination that (a) a size into which the portion of video data is partitioned is larger than a partition size determined by the pre-encoder and (b) the at least one coding parameter is consistent within the partitioning of the portion of video data.

18. The method of claim 11, further comprising:
estimating a quality of the coding of the portion of video data using the copied at least one coding parameter;
responsive to a determination that the coding quality is insufficient, estimating at least one coding parameter of the portion of video data;
coding the portion of video data using the estimated at least one coding parameter of the frame; and
outputting the coded portion of video data using the estimated at least one coding parameter of the portion of video data.

19. The method of claim 11, further comprising:
estimating a quality of the coding of the portion of video data without using the pre-encoder result;
responsive to a determination that the coding quality is insufficient, estimating at least one coding parameter of the portion of video data;
coding the portion of video data using the estimated at least one coding parameter of the portion of video data; and
outputting the portion of video data using the estimated at least one coding parameter of the portion of video data.

20. The method of claim 11, wherein the at least one coding parameter calculated by the pre-encoder includes at least one of a luma intra prediction direction and a chroma intra prediction direction, and the coding of the portion of video data is based on a direction within a predefined angle from at least one of a luma intra prediction direction and a chroma intra prediction direction.

21. The method of claim 20, wherein the at least one of a luma intra prediction direction and a chroma intra prediction direction is indicated by a dominant edge direction calculated by the pre-encoder.

22. The method of claim 11, wherein the at least one coding parameter calculated by the pre-encoder includes a rate distortion cost of each mode, and the coding of the portion of video data includes testing those modes that have an associated rate distortion cost below a predefined threshold value.

23. The method of claim 11, wherein the at least one coding parameter calculated by the pre-encoder includes block pixel statistics indicating at least one of a complexity and an orientation of an edge of a block, and the method uses the at least one of a complexity and an orientation of an edge to determine a bit budget and frame completion.

24. The method of claim 23, wherein the block pixel statistics include mean and variance, and the method selects a quantization parameter with which to code the frame based on the mean and the variance.

25. The method of claim 11, wherein the coding of the portion of video data is based on a comparison of histograms for each pre-encoder mode.

26. The method of claim 11, wherein the coding of the portion of video data includes testing modes, and a smaller set of modes is used based on the at least one coding parameter calculated by the pre-encoder compared with coding the portion of video data without using at least one coding parameter calculated by the pre-encoder.

27. The method of claim 11, further comprising directly transcoding pre-encoded results, wherein the transcoding is adaptively turned off on a block-by-block basis.

28. The method of claim 11, further comprising directly transcoding pre-encoded results, wherein the transcoding is adaptively turned off on a frame-by-frame basis.

29. The method of claim 11, wherein a level of refinement based on the preencoder data is adjustable from region to region within a group of frames.

30. The method of claim 11, wherein the pre-encoder conforms to a first standard and the encoder conforms to a second standard different from the first standard.

31. A coding method, comprising:
receiving a portion of video data;
partitioning the portion of video data;
copying motion information calculated by a pre-encoder for a mode selected by the pre-encoder; and
coding the portion of video data using the copied motion information;
wherein the pre-encoder calculates the motion information and selects the mode based on the portion of video data.

32. The method of claim 31, wherein the portion of video data is a frame.

33. The method of claim 31, wherein the portion of video data is a block.

34. The method of claim 31, further comprising determining whether the mode selected by the pre-encoder matches a testing mode of the method; wherein
the coding of the portion of video data using the copied motion information is performed responsive to a determination that the selected mode matches the testing mode of the method.

35. The method of claim 31, further comprising determining whether the mode selected by the pre-encoder matches a testing mode of the method;
wherein the coding of the portion of video data using the copied motion information is performed responsive to a determination that the selected mode does not match the current testing mode and the pre-encoder selected mode is consistent within the partitioning of the portion of video data.

36. The method of claim 31, further comprising:
estimating a quality of the coding of the portion of video data using the copied motion information;
responsive to a determination that the coding quality is insufficient, estimating motion information for the portion of video data;
coding the portion of video data using the estimated motion information of the portion of video data; and
outputting the coded portion of video data using the estimated motion information of the frame.

37. The method of claim 31, wherein the motion information is derived from block pixel residuals calculated by the pre-encoder.

38. The method of claim 37, wherein the block pixel residuals indicate an orientation of an edge of a block.

39. The method of claim 31, wherein the pre-encoder produces a bitstream conforming to a first coding protocol and the coding engine produces a bitstream conforms to a second coding protocol different from the first standard.

40. A method of determining whether to code a frame of video data, comprising:
receiving a frame of video data;
analyzing the output data of a pre-encoder for a mode selected by the pre-encoder, wherein the pre-encoder calculates (i) a total bits and distortion and (ii) a bits and distortion distribution, based on the frame of video data; and
responsive to a determination that the total bits and distortion is below a threshold, coding the frame of video data; and
responsive to a determination that a bits and distortion distribution is below a threshold, coding the frame of video data.

41. The method of claim 40, wherein output bits of the coding of the frame of video data is based on at least one of (i) the total bits and distortion and (ii) the bits distribution of the frame of video data.

42. The method of claim 40, wherein the coding of the frame of video data is based on an importance of the frame, the importance being predicted by mode distribution and statistics of the frame of video data calculated by the pre-encoder.

43. A non-transitory computer-readable medium storing program instructions that, when executed by a processing device, causes the processing device to:
receive a frame of video data;
partition the frame of video data;
copy at least one coding parameter calculated by a pre-encoder; and
code the frame of video data using the copied at least one coding parameter;
wherein the pre-encoder calculates the at least one coding parameter based on the frame of video data.
